(19) United States
(12) Patent Application Publication
(10) Pub. No.: US 2023/0173592 A1
(43) Pub. Date: Jun. 8, 2023

(54) DRILL BIT STABILIZER AND METHOD OF USE

(71) Applicant: Alain Gary Mazer, Vista, CA (US)

(72) Inventor: Alain Gary Mazer, Vista, CA (US)

(21) Appl. No.: 18/062,766

(22) Filed: Dec. 7, 2022

Related U.S. Application Data
(60) Provisional application No. 63/287,343, filed on Dec. 8, 2021.

(51) Int. Cl. B23B 49/02

(52) U.S. Cl. CPC B23B 49/026; B23B 2226/61; B23B 2228/36; B23B 2240/21; B23B 2260/068

(57) ABSTRACT

A drill bit stabilizer and a method of drilling holes through work surfaces. The drill bit stabilizer includes an adhesive strip with a drill guide hole portion extending outwardly therefrom. The adhesive strip with the drill guide hole portion is preferably transparent and portable for placement on a surface through which a hole is to be drilled. The method includes the steps of providing an adhesive strip with a drill guide hole portion extending therefrom; positioning the adhesive strip on a surface; releasably mounting the adhesive strip to the surface; inserting a drill bit attached to a drill motor into the drill guide hole portion; drilling a hole through the drill guide hole portion and into the surface beneath it; and removing the adhesive strip from the surface after the hole has been drilled.

### CROSS-REFERENCE TO RELATED APPLICATIONS

This application relates to and claims the benefit of U.S. Provisional Application No. 63/287,343, filed Dec. 8, 2021 and entitled “DRILL BIT STABILIZER AND METHOD OF USE,” the entire disclosure of which is expressly incorporated by reference.

### STATEMENT RE: FEDERALLY SPONSORED RESEARCH/DEVELOPMENT

Not Applicable

### DESCRIPTION AND BACKGROUND OF THE INVENTION

The present disclosure relates generally to construction tools. More particularly, the present disclosure relates to a drill bit stabilizer for facilitating the drilling of a hole with a drill motor.

A drill bit is commonly used to create a hole through various surfaces. Drill bits are generally available in different sizes and types for specific applications of drilling into wood, metal, masonry, tile and other materials. A drill bit typically has a shaft that fits into a drill motor and plural cutting edges formed at its distal end. The drill bit is placed on a surface, often times perpendicular but also at an angular orientation to the surface, at the location where a drilled hole is desired. Upon activation of the drill motor to which the drill bit is attached, the turning drill bit bores into the surface and, as it progresses into the surface, allows the drill bit to extend through the surface forming a desired hole.

An existing drill bit presents significant shortcomings in common situations. In this regard, drill bits often times tend to slide or slip across hard or round surfaces until they “grab” and bore into the surface material. Such sliding may result in a damage to the surface and/or bending or breakage of the drill bit and/or a misplaced, i.e., improperly located, hole in the surface. Further, an entire surface may be destroyed, and the operator of the drill motor may be injured by the drill bit or drill kickback.

In the past, some have attempted to solve some of the placement problems of drill bits through the use of templates and mechanical guides that allows the drilling of holes in a surface. However, such templates and guides are not generally suitable to accommodate the multitude of differing drilling applications. One such exemplary prior art a template is shown in U.S. Pat. No. 4,280,776, the contents of which is expressly incorporated herein by reference. While such prior art devices may provide a limited solution for a particular drilling application, such tools are typically insufficient for general use and fail to accommodate differing types of drill bits and/or differing surface drilling applications.

### BRIEF SUMMARY

The present disclosure specifically addresses and eliminates the deficiencies in the prior art and comprises a drill bit stabilizer which can be quickly positioned and removably attached to a work surface into which a hole is desired to be formed. In the preferred embodiment, a relatively thin substrate or strip is provided with a drill guide hole portion extending outwardly therefrom. The strip preferably includes an adhesive backing, which allows the strip to be easily removably attached to a work surface. The strip preferably is formed from a flexible polymer material; however, rigid or semi-rigid materials are also contemplated herein. The drill guide hole portion is preferably reinforced to provide a suitable drill guide function. Preferably, such reinforcement is accomplished by an increased thickness radial side wall or a reinforcement bushing formed of a metal or differing polymer material formed within the drill guide. In the preferred embodiment, a pressure sensitive adhesive is provided on the lower surface of the strip or substrate and is preferably provided with a removable release liner or layer attached thereto.

In operation, the drill bit stabilizer is used by removing the adhesive liner from its lower surface to expose the adhesive formed on the bottom side of the drill bit stabilizer, and the stabilizer is positioned upon differing support surfaces in a desired location where a hole is to be drilled. The adhesive releasably mounts the drill bit stabilizer in a desired position upon the work surface. Subsequently, a conventional drill bit can be positioned within the chuck of a drill motor and the end of the drill bit is positioned within the drill guide hole portion of the drill bit stabilizer. Initiation of the drill motor will cause the drill bit to rotate, wherein the drill bit can be pushed through the drill guide hole portion and through the lower surface of the drill bit stabilizer to contact and accurately drill a hole in the work surface positioned below the drill bit stabilizer. Upon completion of the drilling operation, the drill bit can be removed from the drill bit stabilizer, and the drill bit stabilizer can be peeled off, i.e., removed from the work surface, and preferably discarded. The use of the drill bit stabilizer provides a quick and efficient mechanism for properly locating and accurately drilling a hole in differing work surfaces and utilizing differing types and sizes of drill bits.

### BRIEF DESCRIPTION OF THE DRAWINGS

These and other features of the present disclosure will become more apparent upon reference to the drawings, wherein:

FIG. 1 is a perspective view of the drill bit stabilizer of the present disclosure;

FIG. 2A is a top plan view thereof;

FIG. 2B is a side elevational view thereof;

FIG. 2C is a cross sectional view taken about line 2C of FIG. 2A;

FIG. 3A is a perspective view of the drill bit stabilizer illustrating a releasably adhesive liner disposed upon its lower surface;

FIG. 3B is a perspective view of the drill bit stabilizer of FIG. 3A illustrating the preferable flexible nature of the drill bit stabilizer to allow the stabilizer to be mounted to linear as well as non-linear work surfaces;

FIG. 4 is a perspective view of the drill bit stabilizer mounted upon a flat linear work surface with a drill bit and drill motor aligned thereabove;

FIG. 5 is a perspective view of the drill bit stabilizer disposed about a circular work surface; and

FIG. 6 is a perspective view of the drill bit stabilizer of the present disclosure disposed upon a larger diameter work surface with a drill motor and drill bit disposed thereabove.

### DETAILED DESCRIPTION OF THE PREFERRED EMBODIMENT

Referring to the figures, there is shown the drill bit stabilizer 10 of the present disclosure. As shown, the stabilizer 10 is preferably formed as an elongate strip or membrane 12 having a drill guide portion 14 extending outwardly therefrom. The strip 12 is preferably formed from a thin flexible, semi-flexible or rigid material preferably formed of a flexible polymer material, such as polypropylene. Additionally in the preferred embodiment, the strip 12 is formed of a transparent material or semi-transparent material to allow a user to view through the strip 12 when mounting the same upon a work surface.

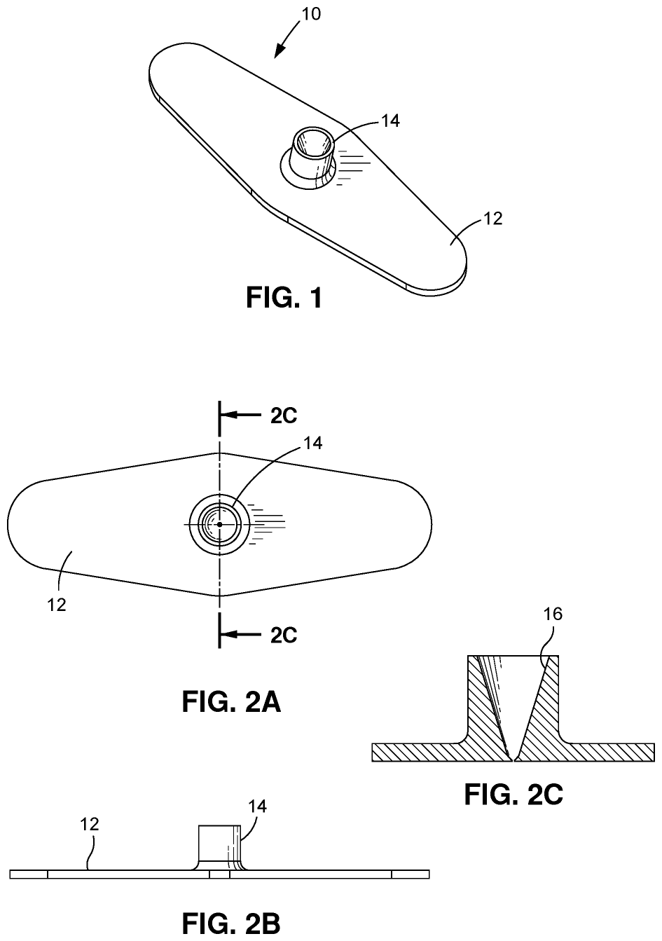

As best shown in FIGS. 1 and 2A-2C, the drill guide portion 14 extends outwardly from the top surface of the strip 12 and includes a hole or aperture 16 extending therethrough or partially therethrough. In the preferred embodiment, the aperture 16 is formed having a generally V-shaped or tapering configuration to accommodate differing size drill bits therein, and additionally provide a self-centering or registering feature of the drill bit extending through the drill guide portion 16. In the preferred embodiment, the drill guide 16 additionally is reinforced to provide greater stability, i.e., stiffness, by having an increased side wall thickness than the strip thickness 12 or, alternatively, may be reinforced utilizing an internal insert bushing (not shown) typically formed of a metal, fabric or different polymer material than the strip 12.

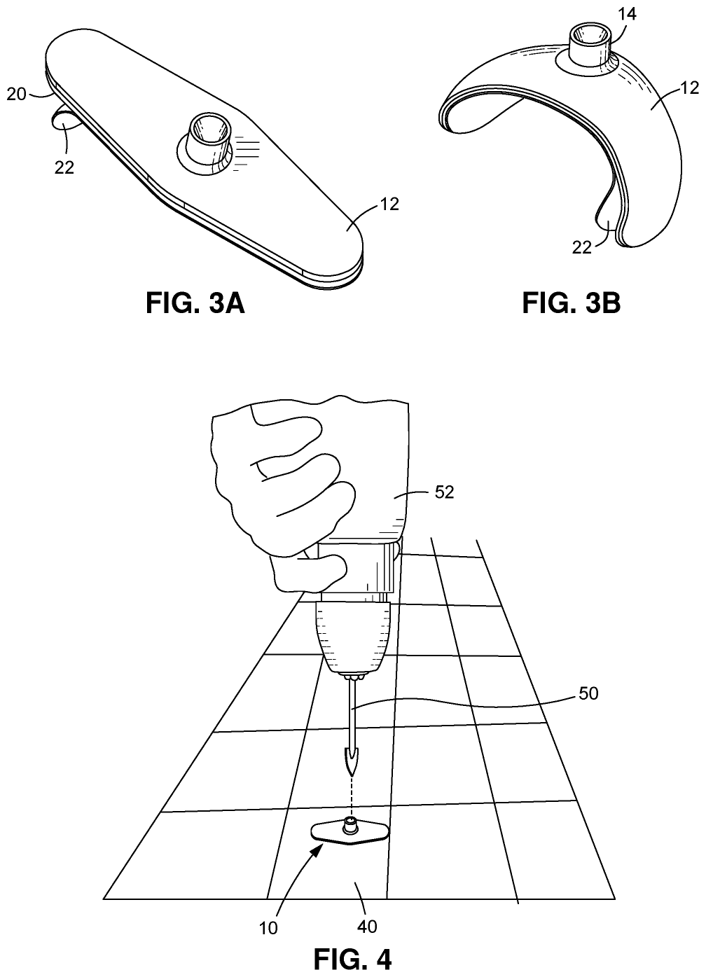

Referring to FIGS. 3A and 3B, the strip 12 preferably includes an adhesive layer 20 formed on its bottom surface, which in the preferred embodiment is a pressure sensitive adhesive to allow the strip 12 to be releasably mounted upon a desired work surface to be drilled. As is well known in the art, the adhesive layer 20 is typically provided with a removable release sheet or liner 22 to protect the adhesive until use. As additionally shown in FIG. 3B, due to the preferable flexible nature of the strip 12, the strip 12 can be manually formed to conform to a desired surface to be drilled, whether a linear surface or non-linear arcuate or curved surface.

Due to the tapering configuration of the aperture 16, the drill bit stabilizer 10 can accommodate variations in the size of the drill bit to be inserted therein. However, it is additionally contemplated that the strip 12 can be formed and provided to a user having differing size apertures 16 formed therein to accommodate differing size drill bits. Further, although in the preferred embodiment the aperture 16 is formed having a V-shaped configuration, those skilled in the art will recognize that cylindrical, octagonal or other configurations are contemplated herein without departing from the spirit of the present disclosure. Additionally, it will be recognized that it is contemplated that the drill bit stabilizer 10 of the present disclosure can be provided as a kit having multiple strips 12, each having the same or differing size apertures 16 formed therein to provide optimal differing drilling applications.

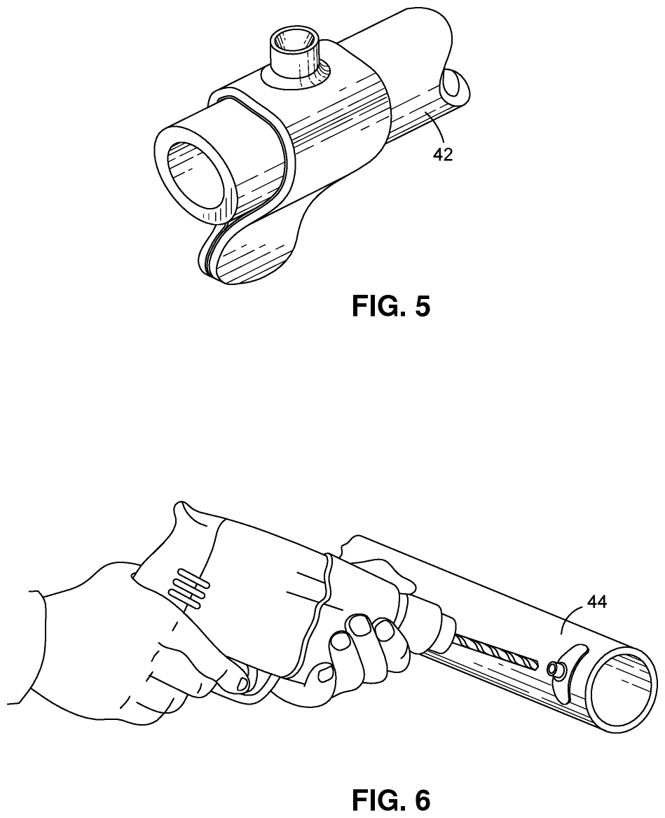

Referring to FIGS. 4, 5 and 6, the use of the drill bit stabilizer 10 of the present disclosure is depicted. In FIG. 4, the drill bit stabilizer 10 is shown applied to a linear or flat work surface 40. FIG. 5 depicts the drill bit stabilizer 10 applied to a small diameter pipe work surface 42. FIG. 6 illustrates the drill bit stabilizer 10 disposed on a larger diameter pipe work surface 44.

In all applications, i.e., FIGS. 4, 5 and 6, the drill bit stabilizer 10 is utilized by initially removing the release layer 22 from its lower surface to expose the adhesive layer 20. The stabilizer 10 may then be positioned upon the support surface 40, 42 and 44 in a desired position and releasably mounted to the surfaces 40, 42 or 44 by way adhesive layer 22. Those skilled in the art will recognize that the accurate positioning of the drill bit stabilizer is facilitated by its preferably transparent or semi-transparent material, which allows the user to see, i.e., view, through the stabilizer 10 and onto the support surface 40, 42 or 44. Once accurately positioned upon the support surface 40, 42 or 44, a conventional drill bit 50 may be mounted into a conventional drill motor 52 as best shown in FIGS. 4 and 6. Subsequently, the drill bit 50 may be positioned within the drill guide hole 16 and the drill motor 52 may be initiated causing a rotation of the drill bit 50. As is typical, a manual force exerted upon the drill motor 52 causes the drill bit 50 to drill through the inner diameter of the drill guide 14 and subsequently into and through the support surface 40, 42 or 44. Due to the reinforcement, i.e., increased rigidity, of the drill guide portion 14, the drill bit 50 is maintained in a desired perpendicular orientation to the work surface 40, 42, and 44, and the drill bit 50 is prevented from walking across the surfaces 40, 42 or 44 thereby drilling an accurate hole or aperture within the support surfaces 40, 42 or 44.

Upon completion of the drilling operation, the drill bit can be easily removed from the drill guide stabilizer 10 by manipulation of the drill motor 52, and due to the releasable nature of the adhesive layer 22, the stabilizer 10 can be removed from, i.e., peeled off, the support surface 40, 42 and 44 and preferably discarded by the user. In the preferred embodiment, it is contemplated that the drill guide stabilizer 10 will be manufactured for single disposable use, however, those skilled in the art will recognize that the same can be manufactured and utilized for multiple drilling applications if desired. Further, those skilled in the art will recognize that although in the preferred embodiment, an adhesive layer 22 is provided on the lower surface of the stabilizer 10, the same can be provided with alternative releasable affixation systems, such as conventional hardware clamps, vices, or clips and/or hook and loop fasteners or manually applied adhesive at the time of use. Further, although depicted for drilling perpendicular holes in a work surface, it is contemplated that other non-perpendicular angles are contemplated at least with common drilling angles, such as 30°, 45°, etc. wherein the drill guide portion will be formed at a corresponding angular orientation to the top surface of the strip 12.

The above description is given by way of example and not by limitation. Given the above description, one skilled in the art could devise variations that are within the scope and spirit of the invention disclosed herein. Further, the various features of the embodiment disclosed herein can be used alone or in varying combinations with each other and are not intended to be limited to a specific combination described herein. Thus, the scope of the claims is not to be limited by the illustrated embodiments.

What is claimed is:

1. A drill bit stabilizer comprising: a strip with a reinforced hole extending outwardly therefrom, said strip adapted to be mounted to a work surface; with the reinforced hole formed to receive and axially register a drill bit therein.

2. The drill bit stabilizer of claim 1, wherein the strip is formed of a polymer material.

3. The drill bit stabilizer of claim 2, wherein the strip is formed of a transparent polymer material.

4. The drill bit stabilizer of claim 2, wherein the strip is formed of a semi-transparent material.

5. The drill bit stabilizer of claim 2, wherein said polymer material is a flexible polymer material.

6. The drill bit stabilizer of claim 1, wherein said strip includes an adhesive backing to mount the strip to a work surface.

7. The drill bit stabilizer of claim 6 further comprising a release layer removably mounted to the adhesive backing formed on the strip.

8. The drill bit stabilizer of claim 2, wherein said reinforced hole has a tapered configuration.

9. A drill bit stabilizer comprising: a strip having a reinforced hole extending upwardly therefrom to receive a drill bit, said strip with said reinforced hole being configured to be mounted with an adhesive to a work surface through which a hole is to be formed by said drill bit; wherein said strip may be removed from the surface and discarded after a hole is drilled through said work surface.

10. The drill bit stabilizer of claim 9, wherein said strip is formed of a polymer material.

11. The drill bit stabilizer of claim 10, wherein said polymer material is a flexible material.

12. The drill bit stabilizer of claim 11, wherein said reinforced hole is formed having a tapered configuration.

13. The drill bit stabilizer of claim 12, wherein a lower surface of the drill bit stabilizer includes an adhesive.

14. The drill bit stabilizer of claim 13, wherein said polymer material is a transparent polymer material.

15. The drill bit stabilizer of claim 13, wherein said polymer material is a semi-transparent polymer material.

16. A method of drilling a hole in a surface, said method comprising: providing a work surface through which a drilled hole is to be made; providing a drill bit stabilizer comprising: a strip, said strip having a reinforced hole extending upwardly from said strip; determining a desired position on said work surface for forming a drilled hole; based on said desired position, aligning said drill bit stabilizer with said desired position and mounting said stabilizer to the work surface with an adhesive; inserting a drill bit into said reinforced hole; with said drill bit mounted to a drill and drilling a hole into said work surface when said drill bit is inserted into the reinforced hole of the drill bit stabilizer.
